(19) United States
(12) Patent Application Publication
(10) Pub. No.: US 2008/0058997 A1
(43) Pub. Date: Mar. 6, 2008

(54) System and method for interactive generator and building electric load control

(75) Inventor: Stanley Walter Timblin, Greensboro, NC (US)

Correspondence Address: TILLMAN WRIGHT, PLLC, PO BOX 471581, CHARLOTTE, NC, 28247, US

(73) Assignee: PowerSecure, Inc.

(21) Appl. No.: 11/101,453

(22) Filed: Apr. 8, 2005

(51) Int. Cl. G06F 19/00

(52) U.S. Cl. 700/295

(57) ABSTRACT

This invention discloses a system and method for interactively managing one or more electric generators that are supplying electric power to one building or to a building complex. The primary application is for providing emergency power in the case of unavailability of the electric utility power. The primary advantage of this approach is that it permits the use of smaller, more cost effective generators for backup during utility outages by powering limited parts of the building equipment depending on the varying needs of equipment in the building during the outage. The features that permit use of smaller generators are the provision of real time data from all relevant sources and the provision of methods to respond in real time as the data are received.

### CROSS-REFERENCE TO RELATED APPLICATIONS

The present application claims the benefit of U.S. Provisional Application No. 60/560,081 which was filed on Apr. 7, 2004, said provisional application incorporated herein by reference.

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Traditional methods for sizing electric generator capacity for emergency power allow for various contingencies by providing a generator or multiple generators with capacity considerably in excess of the maximum load requirement of the building or building complex. Since the cost per kilowatt of installed emergency power is fairly constant over a wide range of generating capacity, these traditional methods have a large cost disadvantage when compared to the present approach.

U.S. Pat. No. 6,624,532 discloses a rather comprehensive and complex system for managing electrical loads serviced by an electric utility, and U.S. Pat. No. 6,633,823 discloses a method for monitoring and controlling energy usage among a plurality of facilities. These inventions are properly characterized as utility-centric, in that they appear to have as their primary focus the control and controlled shedding of electric loads to benefit the electric utility in managing its loads during times of peak usage, or to manage energy delivery on a variable-cost basis to the end user in a non-regulated electric energy environment. While these inventions may over time prove to be valuable contributions to the art, neither deals with the electric energy environment addressed by the present invention, which is the interactive control of emergency power delivered to a single building or building complex whose owners have invested in their own electric power generation equipment for use during electric utility outages.

### BRIEF SUMMARY OF THE INVENTION

This invention discloses a system and method for interactively managing one or more electric generators that are supplying electric power to one building or to a building complex. The primary application is for providing emergency power in the case of unavailability of the electric utility power. A secondary application is for providing load sharing between the electric utility and the local generator when a contract has been signed for this arrangement. Such contracts typically are designed for load sharing in times of heavy electric demand on the electric utility, such as in hot summer weather with high air conditioning demand.

The primary advantage of this approach is that it permits the use of smaller, more cost effective generators for backup during utility outages by backing-up limited parts of the building equipment depending on the varying needs of equipment in the building during the outage. An added feature is an interactive control between the generator and the building load. A generator often needs to limit its capacity when there is a combination of extremely hot weather and normal, gradual, contamination-based reduction of the engine cooling system heat transfer capacity or when there is a partial generator air flow blockage from dust or other airborne contaminants in the air cooling paths to the generator. With the interactive control between the generator and the building control system, the building load automatically matches the reduced capacity of the generator unit, as contrasted to the current practice that permits the generator to attempt to run at its rated capacity and then shut down on engine or generator overheating.

A further advantage of the present invention is that during expected long outages from major storms, the building load can be reduced below the generator capacity to extend the number of hours of running time from the fuel in the on-site tank. This feature allows a remote controlling operator to reset steps in the building control system to operate less equipment in the facility to enable longer running time on a limited fuel supply. The strategy is adjusted by a utility's prediction about when utility power is expected to be back on line or when the generator can be refueled. A simple example is a grocery store that may stay open and run all electrical loads if there will be enough fuel to operate in that mode until the utility power is restored or the generator can be refueled. If there is insufficient fuel for building HVAC loads, the store can still remain open and run refrigeration, lighting and other essential loads. Finally, if there will not be enough fuel to maintain even these loads, the store can be closed and all loads except refrigeration can be turned off to protect stored food.

### BRIEF DESCRIPTION OF THE DRAWINGS

FIG. 1 is a block diagram of the present invention for interactive control by computer between the generator and the building to which it provides electric power.

FIG. 2 is a block diagram which illustrates the transmission of generator data, building electric load data, and remote plus local advisory data to the interactive control computer.

FIG. 3 illustrates the remote control of the generator output and building load from a web-enabled interface, a powerline-enabled interface, a phoneline-enabled interface, a wireless-enabled interface, or from some combination of said interfaces.

### DETAILED DESCRIPTION OF THE INVENTION

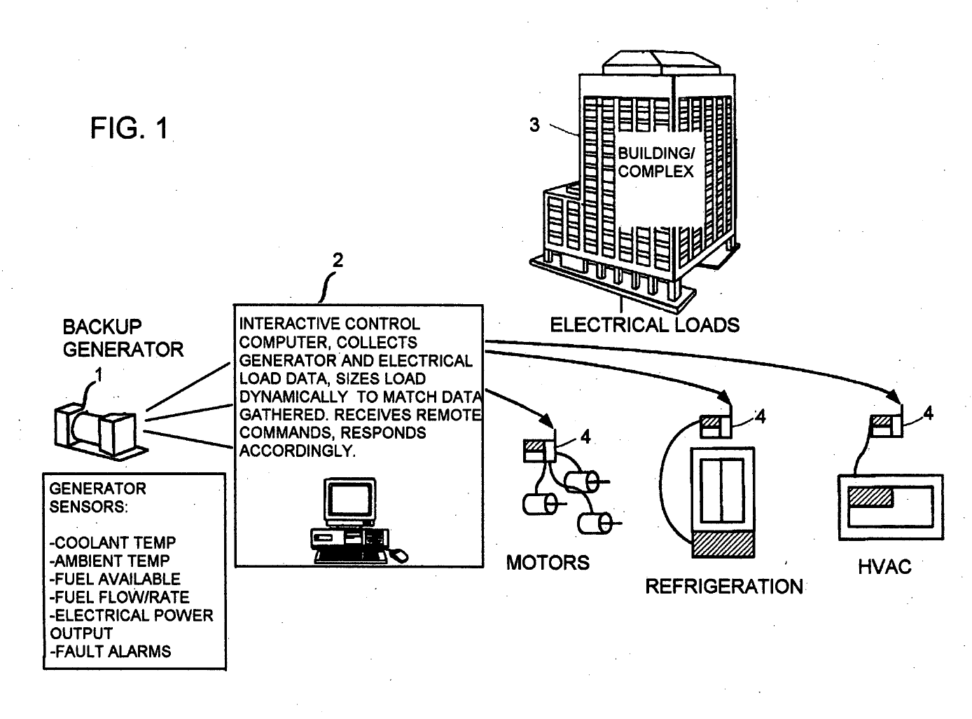

Turning now to the drawings for a detailed description of the present invention, the backup generator 1 as shown in FIG. 1 is connected to interactive control computer 2 which controls the application of electric power to the various loads 4 in the building or building complex 3. Only a single generator is shown in the drawing, but in some cases more than one generator will be present depending on the power requirements of the building site and the other details of a given system implementation. Also, the electrical loads 4 as shown include only electric motors, refrigeration, and heating, ventilation, and air conditioning (HVAC). While these are typically the largest loads to be controlled, other electric loads present in the building complex 3 also may be interactively controlled.

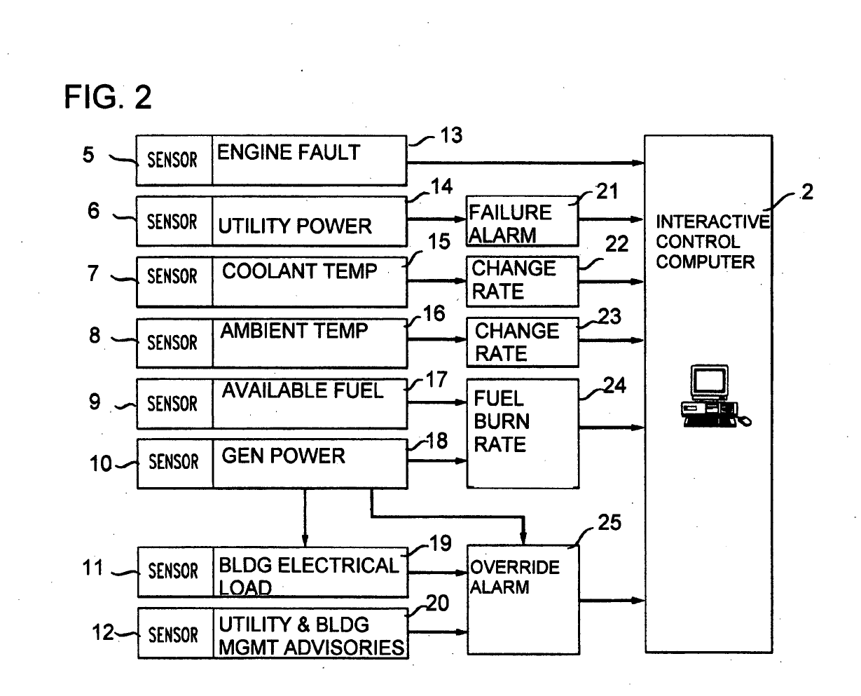

Backup generator 1 is equipped with an array of sensors which gather all of the data necessary to intelligently and interactively control the electric power output of the generator for a variety of purposes and under a variety of conditions. As shown in FIG. 2, interactive control computer 2, hereinafter referred to as ICC 2, receives from a large variety of sensors the necessary signals to dynamically adjust the operating parameters of the system. Among these sensors are those providing signals from the engine providing the mechanical power to operate the generator. Sensor 5 sends an engine fault 13 signal to ICC 2 when appropriate. Sensor 7 relays engine coolant temperature 16 to ICC 2 and thereby allows the important coolant temperature change rate 22 to be calculated, either by an imbedded microcontroller in that signal path or directly by ICC 2. Similarly, sensor 8 measures the ambient temperature 16 in the environment where the generator and its engine are located, allowing the ambient temperature change rate 23 to be calculated, either by an imbedded microcontroller in that signal path or directly by ICC 2. Sensor 9 relays available fuel 17 to fuel bum rate subsystem 24, which in combination with sensor 10 relaying generator power 18 to block 24 enables calculation of the fuel burn rate, either by an imbedded microcontroller in that signal path or directly by ICC 2. Sensors 11 and 12 in FIG. 2 measure the building electrical load 19 and utility and building management advisory updates 20, respectively.

When sensor 6 signals the loss of electrical power via block 14, failure alarm 21 is generated which signals ICC 2 to begin providing backup power to building 3, applying a prearranged initial backup power protocol. Utility company and building management updates and advisories 20 can in a variety of situations produce an override alarm 25, which serves to modify the backup power protocol, changing it to match changed conditions, with directives from the local level or from updates received from a remote site.

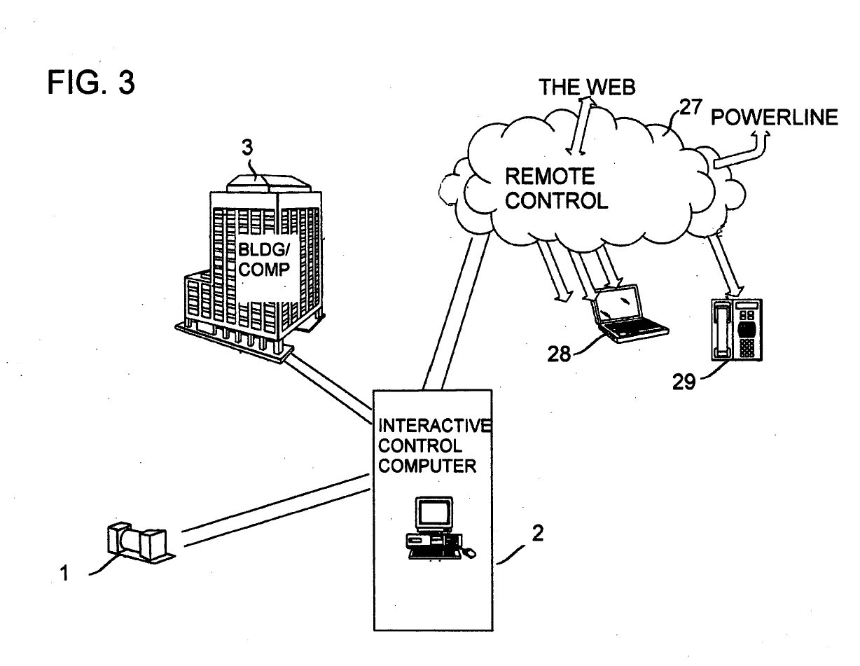

As depicted in FIG. 3, the controlling functions of ICC 2 can be modified from receipt of signals from a variety of sources via remote control module 27, including a wireless link 28, a landline telephone link 29, a utility powerline signaling means, or any of a variety of means linking ICC 2 to the internet.

The same computerized management decision making information and/or automatic control may be used for distribution centers, production facilities with critical processes, and any manufacturing, mining, or retail establishment which has a wide variety of electrical loads to be managed.

What is claimed is:

1. A system for interactive control of one or more electrical generators powering electrical loads to a building or building complex during a partial or complete electrical utility power outage, said system comprising:
a control master which is a digital computer;
a collection of load monitoring sensors;
a collection of generator monitoring sensors;
a collection of load control devices;
a communication network between the control master and the collections of sensors and load control devices;
wherein the control master manages the loads to be powered based upon a stored database of load, generator, generator fuel available, and related characteristics, plus data from the collection of said sensors, data from the building complex management, and data from the electrical utility.

2. A system as in claim 1 wherein the data from said sensors, from said management, from said utility, or any combination thereof are real time data.

3. A system as in claim 1 wherein sensor, load, building management, and electrical utility data are received by hardwired connections.

4. A system as in claim 1 wherein at least some of the data paths are wireless connections.

5. A system as in claim 1 wherein at least some of the data paths are Internet connections.

6. A system as in claim 1 wherein the overall installed generator capacity is optimized to the specific needs of the site, permitting the use of smaller, less expensive generators for backup during utility outages by backing-up limited parts of the building equipment depending on the varying needs of equipment in the building during the outage. The generator sizing choice can often be made optimal by comparing the Net Present Value (NPV) of the utility peak reduction incentive lost by displacing only part of the total peak, particularly considering seasonal variations, and the NPV of the cost of larger or smaller generator(s). The typical objective is to have the size choice provide the highest rate of return on the investment.

7. A system as in claim 2 wherein real time data received from the generator permits the building load to be automatically matched to a reduced capacity of the generator, rather than allowing the generator to continue to run at its rated capacity and then encounter a forced shut down on engine or generator overheating.

8. A system as in claim 2 wherein real time data received from the electrical utility permits an on site or remote controlling operator to reduce the building load below the known generator capacity to extend the number of hours of running time from the fuel in the on-site tank, including the option of extending the running time past the time the tank is to be refilled

9. A method for interactive control of one or more electrical generators powering electrical loads to a building or building complex during a partial or complete electrical utility power outage, said method including:
a master controlling means;
a method for sensing the quantity of electric energy flowing to each of a variety of electric loads;
a method for monitoring various generator and generator engine operating parameters;
a means for controlling the electric energy flowing to each of a variety of electric loads;
a means for receiving information from building complex management and from the electric utility;
a means of signal flow for communication;
wherein the master controlling means can exercise control of loads to be powered based upon a stored database of load, generator, generator fuel available, and related characteristics, and based upon communication data received from quantities of electric energy sensed, from engine and generator parameters monitored, and from building management and electric utility information received.

10. A method as in claim 9 wherein at least some of the communication data are received and can be acted on in real time.

11. A method as in claim 9 wherein the means for enabling signal flow utilizes hard wiring.

12. A method as in claim 9 wherein at least some of the means for enabling signal flow are wireless.

13. A method as in claim 9 wherein at least some of the means for enabling signal flow are Internet-based.

14. A method as in claim 9 wherein the overall installed generator capacity is optimized to the specific needs of the site, permitting the use of smaller, less expensive generators for backup during utility outages by backing-up limited parts of the building equipment depending on the varying needs of equipment in the building during the outage.

15. A method as in claim 10 wherein real time data received from the generator permits the building load to be automatically matched to a reduced capacity of the generator, rather than allowing the generator to continue to run at its rated capacity and then encounter a forced shut down on engine or generator overheating.

16. A method as in claim 10 wherein real time data received from the electrical utility permits an on site or remote controlling operator to reduce the building load below the present generator capacity to extend the number of hours of running time from the fuel in the on-site tank, including the option of extending the running time past the time the tank is to be refilled.
